(19) United States
(12) Patent Application Publication
(10) Pub. No.: US 2007/0011102 A1
(43) Pub. Date: Jan. 11, 2007

(54) KEY MANAGEMENT DEVICE AND METHOD

(76) Inventors: Noriyuki Matsuhira, Kawasaki-shi (JP); Tatsuya Ono, Fuchu-shi (JP); Yoko Masuo, Iruma-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/426,473

(22) Filed: Jun. 26, 2006

(30) Foreign Application Priority Data
Jul. 5, 2005 (JP) 2005-196592

(51) Int. Cl. G06Q 99/00

(52) U.S. Cl. 705/71

(57) ABSTRACT

According to one embodiment, a key management device which is used for decrypting encrypted data which is obtained by encrypting data including titles using title keys, the device comprising a unit which inputs a key data group including pieces of key data to generate the title keys, management information indicating the title keys, and decrypting title information indicating titles, a unit which selects, from the key data group, key data to generate the title keys based on the decrypting title information and the management information and which generates the title keys based on the selected key data, and a unit which stores, in a memory, the generated title keys in order of the titles to be decrypted based on the decrypting title information, wherein the title keys read out from the memory in order are used to decrypt the encrypted data.

### CROSS-REFERENCE TO RELATED APPLICATIONS

This application is based upon and claims the benefit of priority from Japanese Patent Application No. 2005-196592, filed Jul. 5, 2005, the entire contents of which are incorporated herein by reference.

### BACKGROUND

1. Field

One embodiment of the invention relates to a key management device and method of encrypted data.

2. Description of the Related Art

As a recording medium capable of recording a large amount of information such as a video signal, a digital versatile disk (DVD) is prevailing. A movie of about two hours is recorded in the DVD, and information is played back by a reproduction device, so that the movie can freely be watched at home. Digital data such as the movie is encrypted and recorded in order to protect copyrights. A key is encrypted using another key and recorded in the DVD together with the data. The reproduction device decrypts the encrypted key read out from the DVD, by use of another key separately obtained, and the device decrypts the encrypted data by use of a key obtained as a result of the decrypting.

In recent years, the next-generation DVD standard has been developed in which a recording capacity has increased. With the increase of the recording capacity, a large volume of digital data is stored in one disk. When this data is encrypted with one common key, the large volume of digital data is all decrypted by decrypting one key (once). To solve the program, it is proposed that a content recorded in one disk be divided into a plurality of segments, and the key be changed with each segment (see Jpn. Pat. Appln. KOKAI Publication No. 2005-92830).

In an information recording medium in which a large number of contents are recorded, there is provided a constitution in which utilization of each sub-divided content is possible. To be more specific, as segment regions of the content stored in the information recording medium, there are set a plurality of content management units associated with information on titles, indexes and the like. The content management units are associated with unit keys as different cryptography processing keys, and content real data included in at least the content management unit is stored as the encrypted data to which the unit key corresponding to each content management unit has been applied. During reproduction of the content, the unit is identified, and the data is decrypted by applying the unit key corresponding to the unit to reproduce the data.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a constitution of the whole decrypting device including a key management device in a first embodiment of the invention;

FIG. 2 is an exemplary diagram showing a file structure of data recorded in a recording medium (DVD);

FIG. 3 is an exemplary diagram showing an encrypted title key file recorded in the DVD;

FIG. 4 is an exemplary diagram showing management information indicating a title key of each title recorded in the DVD;

FIG. 5 is an exemplary diagram showing playback title information given to a host controller;

FIG. 6 is an exemplary flowchart showing an operation of the first embodiment;

FIG. 7 is an exemplary diagram showing one example of the title key set in a storage unit of a decrypting unit;

FIG. 8 is an exemplary diagram showing one example of the encrypted title key set in the storage unit of the decrypting unit in a second embodiment;

FIG. 9 is an exemplary block diagram showing a constitution of the whole decrypting device including a key management device in a second embodiment of the invention;

FIG. 10 is an exemplary flowchart showing an operation of the second embodiment;

FIG. 11 is an exemplary diagram showing one example of an encrypted title key file; and

FIGS. 12A and 12B are exemplary diagrams showing another example of the encrypted title key file.

### DETAILED DESCRIPTION

Various embodiments according to the invention will be described hereinafter with reference to the accompanying drawings. In general, according to one embodiment of the invention, a key management device which is used for decrypting encrypted data which is obtained by encrypting data including titles using title keys set for the titles, the device comprises a unit which inputs a key data group including pieces of key data to generate the title keys, management information indicating the title keys, and decrypting title information indicating titles to be decrypted; a unit which selects, from the key data group, key data to generate the title keys set to the titles to be decrypted based on the decrypting title information and the management information and which generates the title keys based on the selected key data; and a unit which stores, in a memory, the generated title keys in order of the titles to be decrypted based on the decrypting title information, wherein the title keys read out from the memory in order are used to decrypt the encrypted data.

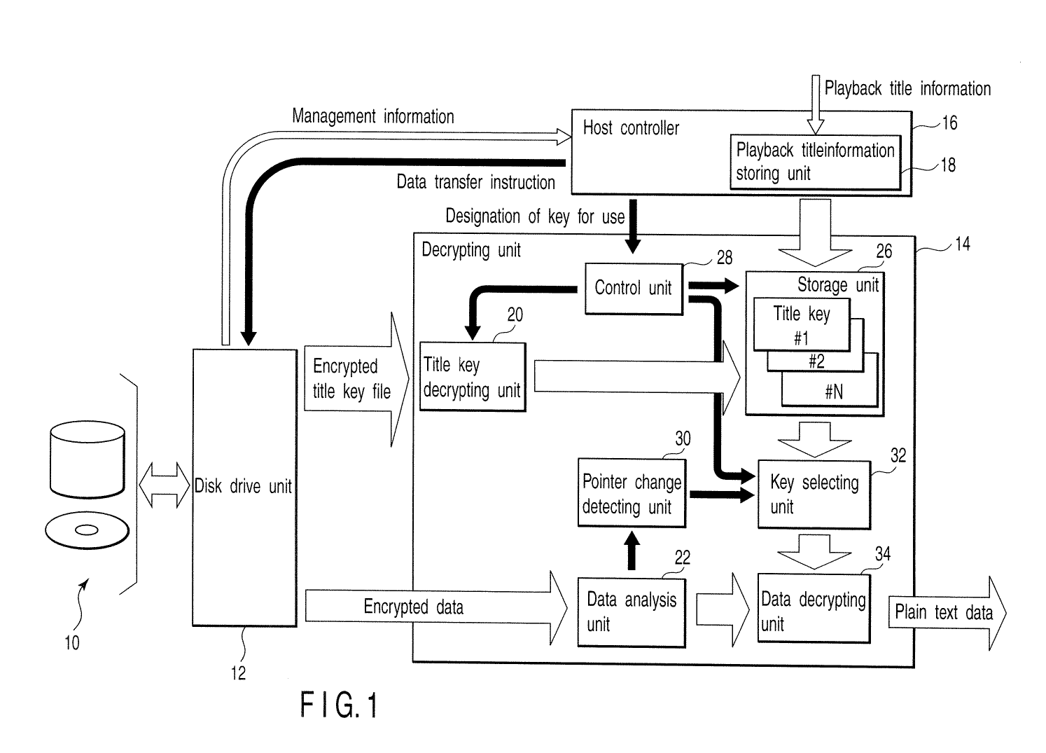

According to an embodiment, FIG. 1 shows a constitution of the whole decrypting device including a key management device in a first embodiment of the invention.

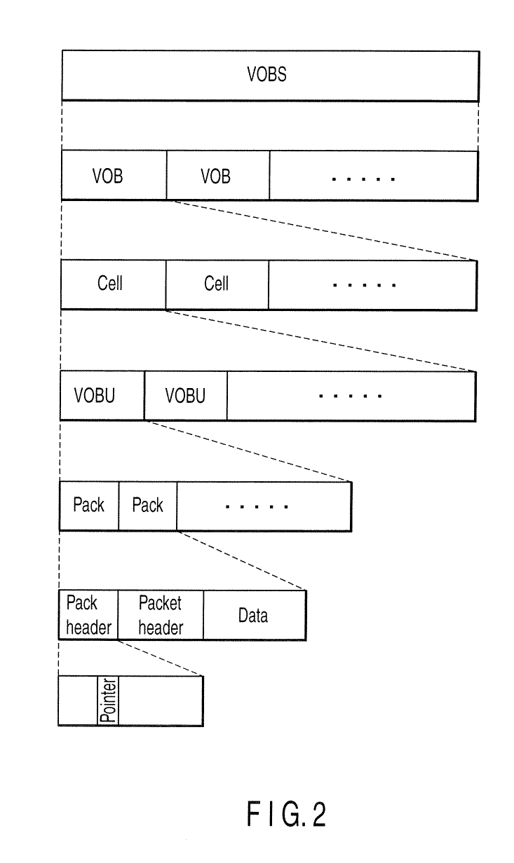

Digital data is encrypted and recorded in a recording medium 10 such as an optical disk (DVD) or a hard disk. FIG. 2 shows a structure of data recorded in the recording medium 10. A video object set VOBS comprises a plurality of video objects VOBs, each video object VOB comprises a plurality of cells, and each cell comprises a plurality of video object units VOBUs. Each video object unit VOBU comprises a plurality of packs, and one pack is 2048 bytes. The pack comprises a pack header and a packet, and the packet comprises a packet header and encrypted data.

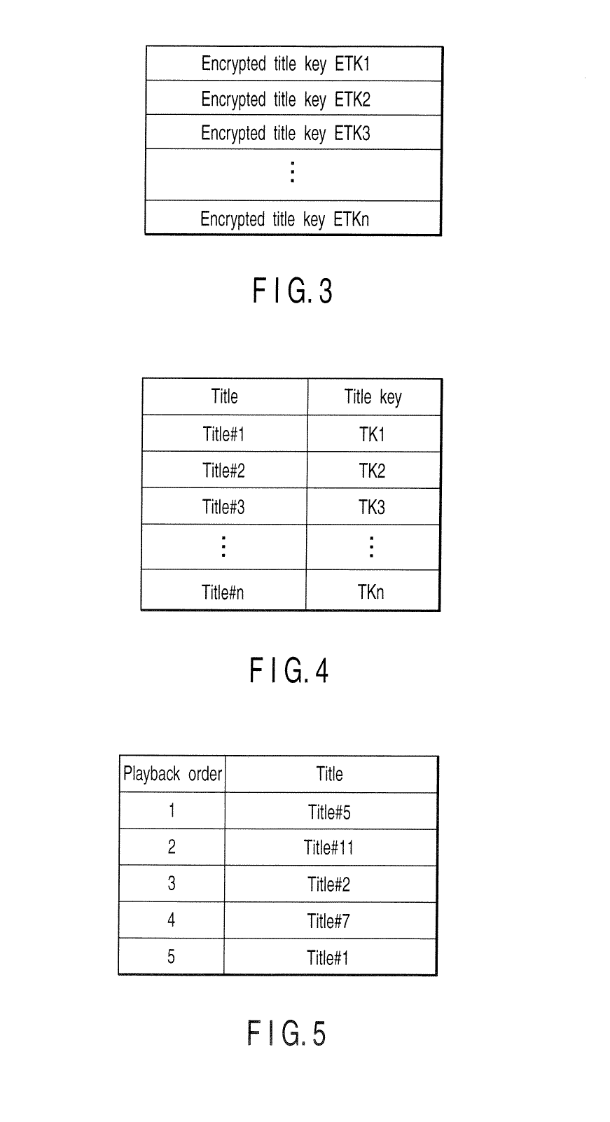

A title key for use in encryption is switchable every video object VOB. That is, a title in which the same title key is used comprises one video object VOB or a plurality of video objects VOBs. The title key is encrypted using still another key (medium key, device key or binding nonce). The device key is information inherent in the decrypting device, and stored in the decrypting device with a tamper resist manner. In the recording medium 10, all title keys used in encrypting the title are recorded as an encrypted title key file shown in FIG. 3.

As described above, the digital data is encrypted using a plurality of title keys. Therefore, since it is necessary to specify the title key for each title during decrypting, the pack header of each pack includes pointer information for specifying the title key. The pointer information indicates an address of the title key used in the encryption of the data in the encrypted title key file of the encrypted title key.

On the other hand, as shown in FIG. 4, the recording medium 10 stores management information indicating the title key used in each title. Here, it is assumed that one DVD can record 1998 titles at maximum (the maximum number of the title keys is 1998).

Turning to FIG. 1, the recording medium 10 is attached to a disk drive 12. It is to be noted that the medium 10 is not exchangeable from the drive 12, in a case where the medium is the hard disk. It is to be noted that the recording medium 10 may be a semiconductor memory such as a flash memory. In this case, instead of the disk drive 12, a read/write unit is provided. Furthermore, instead of attaching the recording medium 10 to the decrypting device itself, the medium may be disposed in another device (server) connected to the decrypting device via a network. In this case, the disk drive 12 is also provided in the other device, the data from the other device is transmitted to the decrypting device via a transmission medium, and the decrypting device is provided with an interface which receives the transmitted data instead of the disk drive 12.

The disk drive 12 is connected to a decrypting unit 14 and a host controller 16 which controls an operation of the decrypting unit 14. Title playback information (FIG. 5) on a playback order of the titles to be decrypted (played back) is input from the outside to the host controller 16, and stored in a storing unit 18.

The disk drive 12 supplies, to the host controller 16, management information (FIG. 4) read from the recording medium 10, supplies the encrypted title key file (FIG. 3) to a title key decrypting unit 20, and supplies encrypted stream data (FIG. 2) to a data analysis unit 22.

The title key decrypting unit 20 decides the encrypted title key by use of a medium key block, a device key or a binding nonce, and obtains the title key. The medium key block and the binding nonce are read out from the recording medium 10. The title key is stored in a semiconductor such as LSI or FPGA, for example, a storage unit 26 including, for example, a flash memory.

The data analysis unit 22 extracts the pointer in the pack header from the stream data, and supplies the extracted pointer to a pointer change detecting unit 30. When a change of the pointer is detected by the pointer change detecting unit 30, a detection result is notified to a key selecting unit 32. The key selecting unit 32 supplies, to an encrypted data decrypting unit 34, any title key stored in the storage unit 26, but switches the title key in accordance with the pointer change to supply the key to the data decrypting unit 34. The data decrypting unit 34 decrypts the encrypted title by use of the title key supplied from the key selecting unit 32.

The host controller 16 gives a data transfer instruction to the disk drive 12, and supplies a designation of the key to be used to a control unit 28 of the decrypting unit 14.

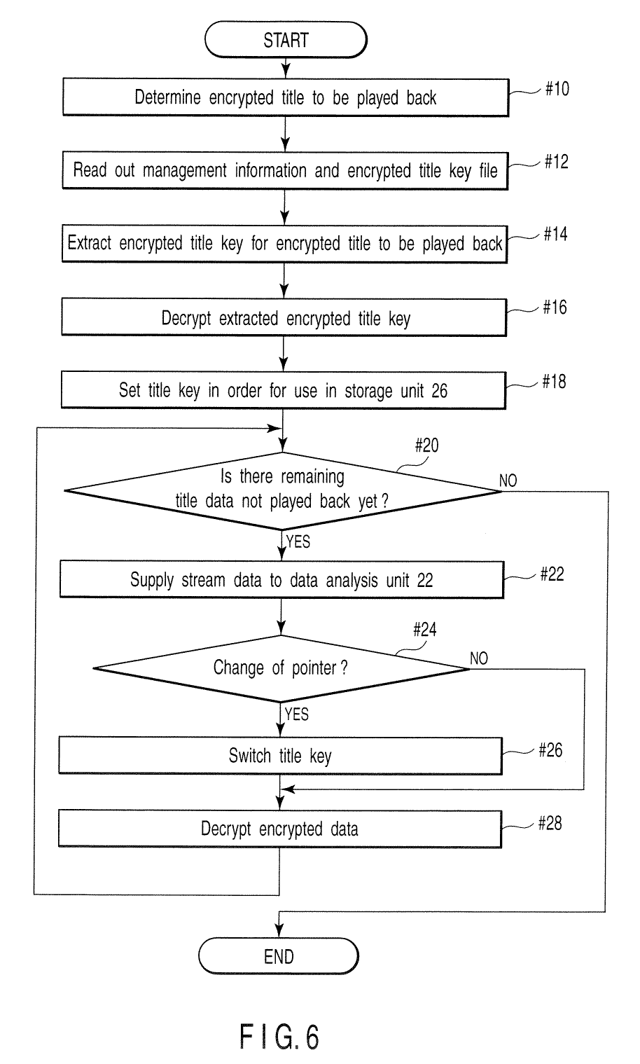

There will be described an operation of a first embodiment with reference to FIG. 6.

In block #10, a user designates the title (encrypted title) desired to be played back, and notifies the host controller 16 of information on the title to be played back. In a case where there are a plurality of titles, the user also determines a playback order of the titles. FIG. 5 shows one example.

In block #12, the disk drive 12 reads out the encrypted title key file (FIG. 3) and the management information (FIG. 4) from the recording medium 10, and supplies them to the title key decrypting unit 20 and the host controller 16, respectively.

In block #14, the host controller 16 notifies the control unit 28 of the title key required for decrypting the title to be played back based on the playback title information and the management information. The control unit 28 controls the title key decrypting unit 20, and extracts the required encrypted title key from the encrypted title key file supplied from the disk drive 12.

In block #16, the title key decrypting unit 20 decrypts the extracted encrypted title key. In an example of the playback title information shown in FIG. 5, title keys TK₁, TK₂, TK₅, TK₇ and TK₁₁ are decrypted.

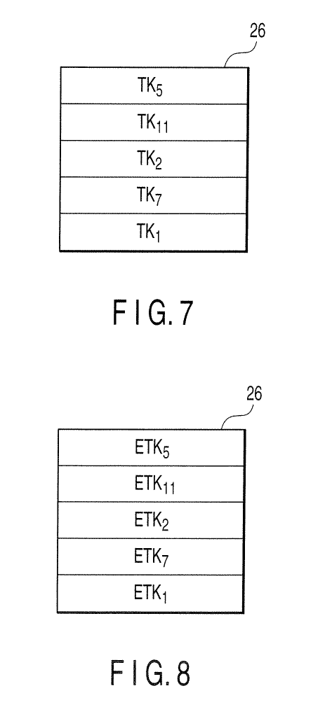

The title keys obtained as a decrypting result are set in the storage unit 26 in order (title playback order) of use in block #18 as shown in FIG. 7. The above operation may be performed any time before the title is actually played back.

When the reproduction of the title actually starts, it is determined in block #20 whether or not there is remaining title data not played back yet. If there is no remaining title data, the operation ends.

If there is remaining title data, the stream data is supplied to the data analysis unit 22 in block #22. The pointer of the pack header indicates the address of the title key for each title. Therefore, when the title changes, the pointer also changes. The pointer change detecting unit 30 detects the change of the pointer, even when the first title is supplied. The key selecting unit 32 selects the top title key (here, TK₅) in response to the first detected change to supply the key to the data decrypting unit 34 (block #24, #26).

In block #28, the data decrypting unit 34 decrypts the encrypted data by use of the title key. When the decrypting of one pack ends in block #28, the processing returns to the block #20, and the above processing is repeated until it is determined that there is not any data to be played back next. That is, the key selecting unit 32 switches the title key to be read out from the storage unit 26 in order in which the title keys are stored, every time the unit detects the change of the pointer.

As described above, according to the first embodiment, since the title key required for decrypting the title to be played back is set beforehand in the storage unit 26 of the decrypting unit 14, it is not necessary to discontinue the playback once and read out the title key from the storage medium at a time when the title to be played back is switched. Therefore, it is possible to seamlessly reproduce a plurality of titles encrypted with different title keys.

There will be described hereinafter another embodiment of a key management device and method. In the description of the other embodiment, the same components as those of the first embodiment are denoted with the same reference numerals, and detailed description thereof is omitted.

In the first embodiment, the title key obtained by decrypting the encrypted title key read out from the recording medium is stored in the storage unit 26 as shown in FIG. 7, but the encrypted title key before decrypted may be stored as shown in FIG. 8.

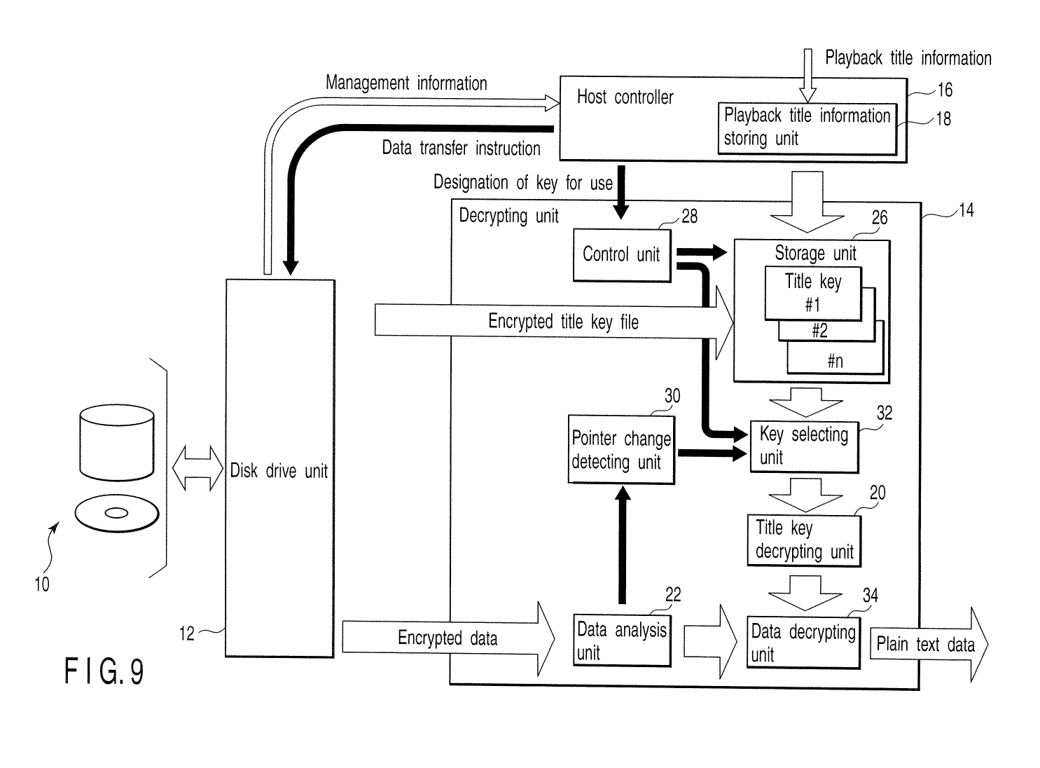

FIG. 9 shows a block diagram of a second embodiment. The block diagram is the same as that of the first embodiment shown in FIG. 1 except that a connection point of the title key decrypting unit 20 moves to a position between the key selecting unit 32 and the data decrypting unit 34.

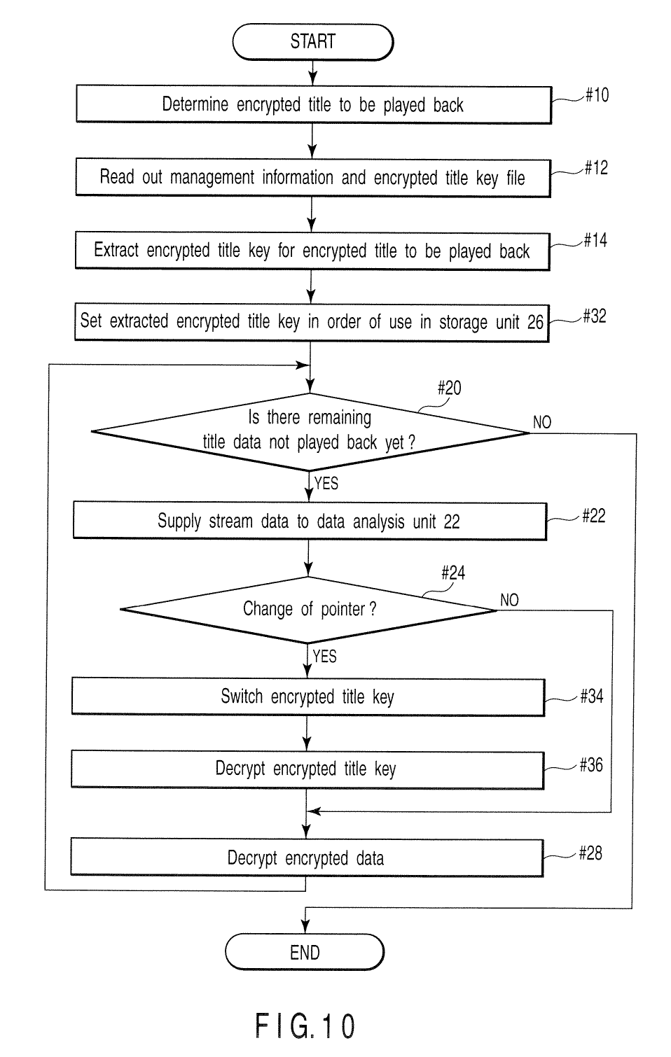

A flowchart of the second embodiment is shown in FIG. 10. The flowchart up to block #14 of extracting a required encrypted title key is the same as that of the first embodiment. In the next block #32, unlike the first embodiment, encrypted title keys ETK₁, ETK₂, ETK₅, ETK₇ and ETK₁₁ which have been extracted are set as such in order of use (title playback order) in the storage unit 26 without being decrypted.

When the playback of the title actually starts, and the change of the pointer is detected in block #24, in block #34 the key selecting unit 32 switches the encrypted title key to be read out from the storage unit 26 in order in which the keys are stored. In block #36, an encrypted title key ETK output from the key selecting unit 32 is decrypted by the title key decrypting unit 20, and supplied as a title key TK to the data decrypting unit 34. In block #28, encrypted data is decrypted.

As described above, even according to the second embodiment, the encrypted title key required for decrypting the title to be played back is set beforehand in the storage unit 26 of the decrypting unit 14. Therefore, it is not necessary to discontinue the playback once and read out the title key from the storage medium at a time when the title to be played back is switched. Therefore, it is possible to seamlessly play back a plurality of titles encrypted with different title keys.

In the above embodiments, the title to be played back is known, and the only required encrypted title key or the only decrypted title key is stored in the storage unit 26 of the decrypting unit 14. As a modification of these embodiments, all of the title keys stored in the recording medium 10 may be stored in the storage unit 26. Even in this case, the titles determined to be played back in a determined order are stored in a playback order in the storage unit 26 in the same manner as in the above embodiment.

That is, in the embodiments of the invention, the encrypted title key recorded in the recording medium is set in the storage unit of the decrypting unit before the encrypted data is decrypted. A state of the title key to be set includes: (1) a case where the encrypted title key is set as such; and (2) the encrypted title key is decrypted so that the key is ready for use, before the key is set. The number of the title keys to be set includes: (1) a case where the only title key of the title to be played back is set; and (2) a case where all of the title keys recorded in the recording medium are set. When they are combined, four embodiments can be realized.

Here, there will be described a typical example of the encrypted title key file.

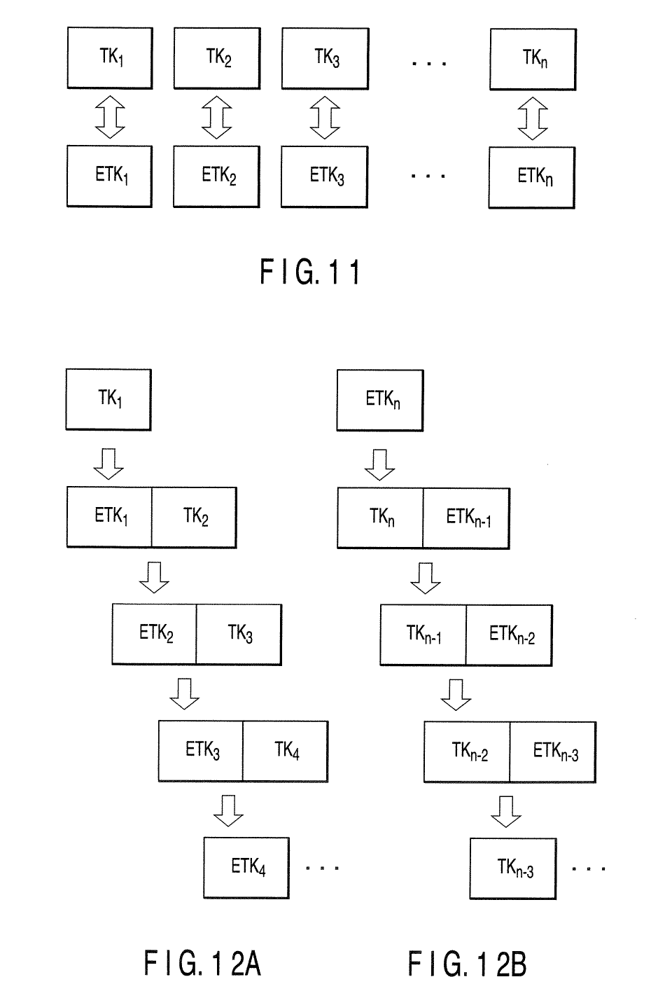

FIG. 11 shows a case where each key is encrypted and decrypted. In this case, i-th encrypted title key ETKᵢ is obtained by encrypting i-th title key TKᵢ only, and the i-th title key TKᵢ is obtained by decrypting the i-th encrypted title key ETKᵢ only. Therefore, the case of FIG. 11 is applicable to any of the four embodiments.

FIG. 12 shows a case where a chain of keys are successively encrypted and decrypted. During the encryption, as shown in FIG. 12A, first encrypted title key ETK₁ is obtained by encrypting first title key TK₁ only, and second (i is 2 or more) or subsequent encrypted title key ETKᵢ is obtained by encrypting the previous encrypted title key ETKᵢ₋₁ and i-th title key TKᵢ. During the decrypting, as shown in FIG. 12B, the last (n-th) title key TKₙ is obtained by decrypting n-th encrypted title key ETKₙ only, and another title key TKₙ₋ᵢ is obtained by decrypting the subsequent title key TKₙ₋ᵢ₊₁ and encrypted title key ETKₙ₋ᵢ. Therefore, in the encrypted title key file encrypted as shown in FIGS. 12A and 12B, all of the encrypted title keys have to be decrypted. In a system in which the encrypted title key is set in the storage unit, and the key is also decrypted during the decrypting of the data, the playback might be discontinued. Therefore, it is preferable that the decrypted title key is set in the storage unit. Furthermore, to obtain j-th title key (after decrypted), only one decrypting of the j-th encrypted title key is insufficient, and the n-th to j-th keys have to be successively decrypted. Therefore, it is preferable that all of the title keys are obtained once, and set beforehand in the storage unit.

According to the embodiments of the invention, a key management device which is used for decrypting encrypted data which is obtained by encrypting data including titles using title keys set for the titles, the device comprises a unit which inputs a key data group including pieces of key data to generate the title keys, management information indicating the title keys, and decrypting title information indicating titles to be decrypted; a unit which selects, from the key data group, key data to generate the title keys set to the titles to be decrypted based on the decrypting title information and the management information and which generates the title keys based on the selected key data; and a unit which stores, in a memory, the generated title keys in order of the titles to be decrypted based on the decrypting title information, wherein the title keys read out from the memory in order are used to decrypt the encrypted data.

In the device, the key data group includes pieces of key data obtained by encrypting the title keys. The key data group includes pieces of key data obtained by successively encrypting the title keys so that a result of the encryption of the previous key is reflected.

According to the embodiments of the invention, a key management device which is used for decrypting encrypted data which is obtained by encrypting data including titles using title keys set for the titles, the device comprises a unit which inputs a key data group including pieces of key data to generate the title keys, management information indicating the title keys, and encrypting title information indicating titles to be decrypted; a unit which selects, from the key data group, pieces of key data to generate the title keys set to the titles to be decrypted based on the decrypting title information and the management information; and a unit which stores, in a memory, the selected pieces of the key data in order of the titles to be decrypted based on the decrypting title information, wherein the pieces of the key data read out from the memory in order are used to decrypt the encrypted data.

In the device, the key data group includes pieces of key data obtained by encrypting the title keys.

According to the embodiments of the invention, a key management device which is used for decrypting encrypted data which is obtained by encrypting data including titles using title keys set for the titles, the device comprises a unit which inputs a key data group including pieces of key data to generate the title keys, management information indicating the title keys, and decrypting title information indicating titles to be decrypted; a unit which generates all of the title keys based on all of the pieces of key data of the key data group; and a unit which stores, in a memory, the generated title keys based on the decrypting title information and which stores, in the memory, the title keys having a known order of the titles to be played back in order of the titles to be decrypted, wherein the title keys read out in order from the memory are used to decrypt the encrypted data.

In the device, the key data group includes pieces of key data obtained by encrypting the title keys. The key data group includes pieces of key data obtained by successively encrypting the title keys so that a result of the encryption of the previous key is reflected.

According to the embodiments of the invention, a key management device which is used for decrypting encrypted data which is obtained by encrypting data including titles using title keys set for the titles, the device comprises a unit which inputs a key data group including pieces of key data to generate the title keys, management information indicating the title keys, and decrypting title information indicating titles to be decrypted; and a unit which stores, in a memory, all of the pieces of key data of the key data group based on the decrypting title information and which stores, in the memory, pieces of key data having a known order of the titles to be played back in order of the titles to be decrypted, wherein title keys generated based on the pieces of key data read out in order from the memory are used to decrypt the encrypted data.

In the device, the key data group includes pieces of key data obtained by encrypting the title keys.

According to the embodiments of the invention, a key management method which is used for decrypting encrypted data which is obtained by encrypting data including titles using title keys set for the titles, the method comprises inputting a key data group including pieces of key data to generate the title keys, management information indicating the title keys, and decrypting title information indicating titles to be decrypted; selecting, from the key data group, key data to generate the title keys set to the titles to be decrypted based on the decrypting title information and the management information and generating the title keys based on the selected key data; and storing, in a memory, the generated title keys in order of the titles to be decrypted based on the decrypting title information, wherein the title keys read out from the memory in order are used to decrypt the encrypted data.

According to the embodiments of the invention, a key management method which is used for decrypting encrypted data which is obtained by encrypting data including titles using title keys set for the titles, the method comprises inputting a key data group including pieces of key data to generate the title keys, management information indicating the title keys, and decrypting title information indicating titles to be decrypted; selecting, from the key data group, pieces of key data to generate the title keys set to the titles to be decrypted based on the decrypting title information and the management information; and storing, in a memory, the selected pieces of the key data in order of the titles to be decrypted based on the decrypting title information, wherein the pieces of the key data read out from the memory in order are used to decrypt the encrypted data.

According to the embodiments of the invention, a key management method which is used for decrypting encrypted data which is obtained by encrypting data including titles using title keys set for the titles, the method comprises inputting a key data group including pieces of key data to generate the title keys, management information indicating the title keys, and decrypting title information indicating titles to be decrypted; generating all of the title keys based on all of the pieces of key data of the key data group; and storing, in a memory, the generated title keys based on the decrypting title information and storing, in the memory, the title keys having a known order of the titles to be played back in order of the titles to be decrypted, wherein the title keys read out in order from the memory are used to decrypt the encrypted data.

According to the embodiments of the invention, a key management method which is used for decrypting encrypted data which is obtained by encrypting data including titles using title keys set for the titles, the method comprises inputting a key data group including pieces of key data to generate the title keys, management information indicating the title keys, and decrypting title information indicating titles to be decrypted; and storing, in a memory, all of the pieces of key data of the key data group based on the decrypting title information and storing, in the memory, pieces of key data having a known order of the titles to be played back in order of the titles to be decrypted, wherein title keys generated based on the pieces of key data read out in order from the memory are used to decrypt the encrypted data.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A key management device which is used for decrypting encrypted data which is obtained by encrypting data including titles using title keys set for the titles, the device comprising:
a unit which inputs a key data group including pieces of key data to generate the title keys, management information indicating the title keys, and decrypting title information indicating titles to be decrypted;
a unit which selects, from the key data group, key data to generate the title keys set to the titles to be decrypted based on the decrypting title information and the management information and which generates the title keys based on the selected key data; and
a unit which stores, in a memory, the generated title keys in order of the titles to be decrypted based on the decrypting title information, wherein the title keys read out from the memory in order are used to decrypt the encrypted data.

2. The key management device according to claim 1, wherein the key data group includes pieces of key data obtained by encrypting the title keys.

3. The key management device according to claim 1, wherein the key data group includes pieces of key data obtained by successively encrypting the title keys so that a result of the encryption of the previous key is reflected.

4. A key management device which is used for decrypting encrypted data which is obtained by encrypting data including titles using title keys set for the titles, the device comprising:
a unit which inputs a key data group including pieces of key data to generate the title keys, management information indicating the title keys, and decrypting title information indicating titles to be decrypted;
a unit which selects, from the key data group, pieces of key data to generate the title keys set to the titles to be decrypted based on the decrypting title information and the management information; and
a unit which stores, in a memory, the selected pieces of the key data in order of the titles to be decrypted based on the decrypting title information, wherein the pieces of the key data read out from the memory in order are used to decrypt the encrypted data.

5. The key management device according to claim 4, wherein the key data group includes pieces of key data obtained by encrypting the title keys.

6. A key management device which is used for decrypting encrypted data which is obtained by encrypting data including titles using title keys set for the titles, the device comprising:
a unit which inputs a key data group including pieces of key data to generate the title keys, management information indicating the title keys, and decrypting title information indicating titles to be decrypted;
a unit which generates all of the title keys based on all of the pieces of key data of the key data group; and
a unit which stores, in a memory, the generated title keys based on the decrypting title information and which stores, in the memory, the title keys having a known order of the titles to be played back in order of the titles to be decrypted, wherein the title keys read out in order from the memory are used to decrypt the encrypted data.

7. The key management device according to claim 6, wherein the key data group includes pieces of key data obtained by encrypting the title keys.

8. The key management device according to claim 6, wherein the key data group includes pieces of key data obtained by successively encrypting the title keys so that a result of the encryption of the previous key is reflected.

9. A key management method which is used for decrypting encrypted data which is obtained by encrypting data including titles using title keys set for the titles, the method comprising:
inputting a key data group including pieces of key data to generate the title keys, management information indicating the title keys, and decrypting title information indicating titles to be decrypted;
selecting, from the key data group, key data to generate the title keys set to the titles to be decrypted based on the decrypting title information and the management information and generating the title keys based on the selected key data; and
storing, in a memory, the generated title keys in order of the titles to be decrypted based on the decrypting title information, wherein the title keys read out from the memory in order are used to decrypt the encrypted data.
